(19) United States
(12) Patent Application Publication
(10) Pub. No.: US 2026/0050151 A1
(43) Pub. Date: Feb. 19, 2026

(54) IMPROVEMENTS IN OR RELATING TO AN ILLUMINATION DEVICE

(71) Applicant: REFEYN LTD, Oxford (GB)

(72) Inventors: David John Lehar GRAHAM, Oxford (GB); Daniel Richard COLE, Oxford (GB); Gavin YOUNG, Oxford (GB)

(21) Appl. No.: 19/102,902

(22) PCT Filed: Aug. 14, 2023
(86) PCT No.: PCT/GB2023/052138

§ 371 Date: Feb. 11, 2025

(30) Foreign Application Priority Data
Aug. 12, 2022 (GB) 2211801.2

(51) Int. Cl. G02B 21/08

(52) U.S. Cl. CPC G02B 21/082

(57) ABSTRACT

A critical illumination device is provided. The critical illumination device comprise a uniform illumination of an object in a reflected light microscope, the critical illumination device comprising a coherent or partially coherent light source; an optical fibre coupled with the light source, wherein the fibre comprises a core with a diameter of at least 15 microns and a numerical aperture of 0.1 to 0.5; and at least one collimator lens positioned at the focal length from the tip of the optical fibre, wherein the collimator lens is configured to match the numerical aperture of the optical fibre to couple light out of optical fibre.

The present invention relates to an illumination device and in particular, a critical illumination device for providing a uniform illumination of an object in a reflected light microscope. A reflection light microscope and a method for illuminating an object are also provided.

Illumination devices supply light in various apparatus, and may alternatively be described as a light source. In microscopy, it is essential to have illumination appropriate for both viewing and imaging. Various light sources and means of illumination are known in the art.

Critical illumination is a method of sample illumination generally used for transmitted and reflected light. In brief, critical illumination focuses an image of a light source onto the sample for bright illumination. To date, a drawback of this type of illumination is that the field of view (FoV) is not evenly illuminated.

Another limitation of critical illumination is the formation of an image of the light source in the sample image plane. Kohler illumination addresses the limitations of critical illumination by ensuring the image of the light source is not visible in the sample plane. In addition, Kohler illumination is able to provide even illumination of the sample over the field of view and thus, it reduces image artefacts and provides high sample contrast. To date, Kohler illumination is the predominant technique for sample illumination in light microscopy.

Optical microscopy is one type of imaging technique that has been extensively used to investigate biological and/or chemical structures and their dynamical behaviour on a microscopic and/or a nanoscopic length scale. Optical microscopy inherently relies upon an illumination device or light source. Optical microscopy techniques includes, but are not limited to Dark-field illumination, Wide-field or rapid beam scanning microscopic methods for illuminating the sample.

Mass photometry is one of the techniques that utilises wide-field scanning microscopic method. Mass photometry is a type of optical microscopy that provides an efficient and effective method to measure the mass of single molecules in a sample. This technique measures the mass of individual molecules by capturing the light scattered by each molecule at an interface. Extraction of the scattering contrast provides an indirect measurement of the mass. Mass photometry builds on the principles of interference reflection microscopy and single particle interferometric scattering microscopy. In mass photometry, the illuminating light may be spatially and temporally coherent, for example using a laser as the light source. To date, critical illumination devices have not been suitable for use in mass photometers, since the illumination is not uniformly even.

The illumination device of the present invention is suitable for use in reflected light microscopes.

In the art, there are many techniques and apparatuses that rely upon illumination devices. Given that the techniques can vary in terms of their illumination requirements, including illumination power and stability, a device suitable for medical/veterinary imaging is necessarily different to devices for microscopy.

Imaging techniques have been used to investigate a biological and/or chemical structures and their dynamical behaviour. Imaging techniques such as tomographic imaging for example, PET or CT scans requires an optical scanner to provide excitation light from a fibre coupled laser with small spot sizes. High powered lasers are often used for tomographic imaging as they allow sufficient power to be delivered to locations deep within a thick sample in order to excite fluorescent species located therein. However, tomographic imaging utilises multiple elements such as multiple excitation sources and galvanometer optical scanners to perform multi-spectral imaging. This requires a large amount of power and are prone to breaking. The scanning element are expensive and require precise alignment. Hence, this can be time consuming, expensive and inefficient set-up process for the user. Furthermore, the focused beam results in a high peak power density at the sample, which can damage the biological objects within the sample. Such an illumination device would not be suitable for use in a reflected light microscope.

Digital holography includes a collimated light source, such as that from the collimated output of a single mode fibre, providing illumination for the taking of holographic images.

Digital holography does not require a microscope as it enables the reconstruction of an electric field at a given plane a-posteriori—but it relies upon a computer to perform a numerical reconstruction. The computer performs a numerical reconstruction in which the light wave front information originating from the object is digitally recorded as a hologram, from which the computer then calculates the object image by using a numerical reconstruction algorithm. This can often be a complex and time consuming process for the user. Furthermore, the use of a single mode fibre in holography often provides high spatial coherence, which leads to significant speckle when using a laser and therefore affects the overall image quality.

Dark-field illumination is a technique in optical microscopy that eliminates illuminated light from the light scattered by the sample. This yields an image with a dark background around the specimen, and is essentially the complete opposite of brightfield illumination. Since dark-field microscopy eliminates the majority of the bright light, this form of illumination often requires the use of expensive high sensitivity image detectors to detect weakly scattering objects. In general, dark-field Illumination is not well suited for critical illumination.

Wide-field microscopic methods illuminate the sample of interest with a uniform, collimated light beam and the reflected light is captured and analysed to determine the mass of any molecules in the sample. A uniform and collimated light beam is used which causes some level of coherence. Images of the sample obtained from these surfaces by coherent imaging systems such as a laser suffer from a common interference phenomenon called speckle. These speckles may obscure or cover-up the imaged sample and therefore adversely affect the final mass measurements in techniques such as mass photometry. Wide-field illumination may further result in a loss of spatial resolution due to the extended Point-Spread Functions (PSFs), which is a result of the interference between the scattered light and the illumination light.

Alternatively, rapid beam scanning technique uses a focused beam and a scanning element, such as an Acousto Optic Deflector (AOD), to move the beam across the sample. This is scanned across a particular field of view (FoV) that encompasses the sample. The final image will be free of any speckling, since it is composed of the sum of different spots of the sample illuminated at different moments within the detector exposure time. However, the scanning elements require large amounts of power and are prone to breaking. The scanning element are expensive and require precise alignment. Hence, this can be time consuming, expensive and inefficient for the user. Furthermore, the focused beam results in a high peak power density at the sample, which can damage the biological objects within the sample.

Important factors to consider when selecting a microscopic method are the desired illumination area (i.e. FoV) and the illumination numerical aperture (NA) of the light used. A suitable illumination area will allow the sample to be imaged in its entirety and ensure the sample is fully illuminated. Critical illumination is a method of sample illumination used for transmitted and reflected light (trans- and epi-illuminated) optical microscopy. Critical illumination focuses an image of a light source onto the sample for bright illumination. However, critical illumination generally has problems with evenness of illumination, as an image of the illumination source, for example a halogen lamp filament, is often visible in the resulting image. Hence, it is important to ensure a high degree of illumination uniformity to allow for improvements in identifying features of the image and quantifying them. It is also of importance to use light with higher illumination numerical aperture as this can improve the spatial resolution of the final image.

Therefore, there is a requirement to overcome the various issues as mentioned above to provide a device and method for enabling critical illumination with high illumination uniformity, as well as reducing speckle contrast.

It is against this background that the present invention has arisen.

According to an aspect of the present invention, there is provided a critical illumination device for providing a uniform illumination of an object in a reflected light microscope, the critical illumination device comprising
a coherent or partially coherent light source;
an optical fibre coupled with the light source, wherein the fibre comprises a core with a diameter of at least 15 microns and a numerical aperture of 0.1 to 0.5; and
at least one collimator lens positioned at the focal length from the tip of the optical fibre, wherein the collimator lens is configured to match the numerical aperture of the optical fibre to couple light out of the optical fibre.

According to another aspect of the present invention, there is provided a critical illumination device for providing a uniform illumination of an object in a reflected light microscope, the illumination device comprising
a coherent or partially coherent light source;
an optical fibre coupled with the light source, wherein the fibre comprises a core with a diameter of at least 15 microns and a numerical aperture of 0.1 to 0.5; and
at least one collimator lens positioned at its focal length from the tip of the optical fibre, wherein the collimator lens is configured to match the numerical aperture of the optical fibre to couple light into and/or out of optical fibre.

In some embodiments, there is provided a critical illumination device for providing a uniform illumination of an object in a reflected light microscope, the illumination device comprising a coherent or partially coherent light source; an optical fibre coupled with the light source, wherein the fibre comprises a core with a diameter of at least 15 microns and a numerical aperture of 0.1 to 0.5; and at least one collimator lens or a focusing element, such as a curved mirror, positioned at its focal length from the tip of the optical fibre, wherein the collimator lens is configured to match the numerical aperture of the optical fibre to couple light into the optical fibre.

The critical illumination device as disclosed herein can provide critical illumination with high illumination uniformity of the object. The critical illumination device comprises a coherent or partially coherent light source to provide bright illumination in order to form an image of the object.

The term “focal length” as disclosed herein, unless otherwise specified, refers to the on-axis distance between the lens or focusing element to the point in space where parallel rays incident on the lens or focusing element converge to a focus.

The object can be, but is not limited to, a biomolecule such as a nucleic acid, a protein, a protein complex, a lipoprotein, a polypeptide, an antibody or antibody fragment thereof, an enzyme, a virus or a viral vector such as adenovirus and/or lentivirus, a particle, a nanoparticle, a compound, a molecule, an ion or a quantum dot.

The object may be present in a sample. The object may be suspected of being present in the sample. The sample may be any suitable sample including a biological sample (for example blood, serum, blood fractions, saliva, tears, sweat, urine, semen, amniotic fluid, cerebrospinal fluid, bile or Interstitial fluid. The sample may be an environmental sample, such as water, or waste such as sewage. The sample may be an industrial sample, such as from a manufacturing process. The manufacturing process could be any suitable process, including food manufacture, biological or chemical manufacture. The sample may originate from processes for manufacturing cell or gene therapy, and may optionally originate from a laboratory.

An example of quantitative imaging of objects using the device and method of the present invention may include, but is not limited to, resolving populations of viral vectors such as adenovirus, adeno-associated virus (AAV) and/or lentivirus by investigating its genome content, i.e. determine whether the virus is empty or full, based on light scattering contrast.

The optical fibre is a multimode fibre that may be coupled with the light source to enable critical illumination with high illumination uniformity, as well as reducing speckle contrast. A single mode fibre would not provide high illumination uniformity in this case because the output has a gaussian profile, which is not uniform when used for critical illumination.

Thus, an aim of the present invention is to provide a critical illumination device, such that a large range of illumination angles for higher spatial resolution is achieved with little loss of contrast. The use of a multimode optical fibre coupled to a light source enables critical illumination with high illumination uniformity of the object. Imaging can occur at the end of the multimode optical fibre. As disclosed herein, the optical fibre can be provided with a minimal length, with longer fibres, i.e. greater than 2 metres, minimising speckle contrast. Suitable alignment of the optical fibre along the optical axis will assist in avoiding aberrated Point-Spread Functions (PSFs) over the field of view. Consequently, the device of the present invention can be used to give a high spatial resolution, high contrast microscope with uniform illumination capable for quantitative imaging of an object.

Quantitative imaging of an object can be broadly in the 1 to 500 nm range. In some embodiments, the object may be more than 1, 50, 100, 150, 200, 250, 300, 350, 400 or 450 nm. In some embodiments, the object may be less than 500, 450, 400, 350, 300, 250, 200, 150, 100 or 50 nm. In some embodiments, the object can be in the 20 to 200 nm size range. In some embodiments, the object may be more than 20, 30, 40, 50, 60, 70, 80, 90, 100, 110, 120, 130, 140, 150, 160, 170, 180 or 190 nm. In some embodiments, the object may be less than 200, 190, 180, 170, 160, 150, 140, 130, 120, 110, 100, 90, 80, 70, 60, 50, 40 or 30 nm. In some embodiments, the size of the object may be less than 20, 18, 16, 14, 12, 10, 8, 6, 4 or 2 nm. In some embodiments the object may be more than 2, 4, 6, 8, 10, 12, 14, 16 or 18 nm.

In some embodiments, the optical fibre may have a numerical aperture (NA) of more than 0.12, 0.13, 0.14, 0.15, 0.16, 0.17, 0.18, 0.19, 0.20, 0.21, 0.22, 0.23 or 0.24. In some embodiments, the optical fibre may have a numerical aperture (NA) of less than 0.25, 0.24, 0.23, 0.22, 0.21, 0.20, 0.19, 0.18, 0.17, 0.16, 0.15, 0.14 or 0.13. In some embodiments, the optical fibre may have a numerical aperture (NA) of more than 0.25, 0.26, 0.27, 0.28, 0.29, 0.30, 0.31, 0.32, 0.33, 0.34, 0.35, 0.36, 0.37, 0.38 or 0.39. In some embodiments, the optical fibre may have a numerical aperture (NA) of less than 0.40, 0.39, 0.38, 0.37, 0.36, 0.35, 0.34, 0.33, 0.32, 0.31, 0.30, 0.29, 0.28, 0.27, 0.26 or 0.25.

The microscope can be a reflected light microscope or a reflection mode microscope with illumination provided by an SLD or a modulated laser diode coupled into a multimode optical fibre. In some embodiments, the reflected light microscope can be an interferometric scattering microscope.

In some embodiments, the output of the fibre imaged onto the sample (critical illumination) can provide uniform illumination with high illumination NA. Speckle contrast can be reduced further by increasing the fibre length, for example by using a fibre of more than 10 metres in length, or by moving the fibre rapidly compared to the acquisition rate. In some embodiments, the illumination device further comprises an optical element. The speckle contrast can be reduced by rapidly changing the pointing or divergence of the input light into the fibre using the optical element such as a deformable mirror and/or a light deflecting element.

As used herein and unless otherwise specified, the term “coupled”, “coupling” or “coupled with” refers to the optical communication and more particularly, the process of transferring light between optical components. For example, light coupling can occur between the optical fibre and the light source. The optical components such as the optical fibre and the light source can be directly or indirectly connected. Any suitable coupling technique may be used for example waveguide coupling.

In some embodiments, the collimator lens can be provided for coupling light into the optical fibre. The collimator lens is configured to match with the numerical aperture of the optical fibre to ensure that no light is lost (focusing all light into the fibre acceptance angle) and that all modes of the optical fibre are efficiently used. This can help achieve a uniform output exiting at one end of the fibre, resulting in a more uniform illumination pattern.

To provide the desired uniform illumination it is important to have a collimator lens positioned at one focal length away from one end, i.e. the exit face, of the fibre to collect and collimate the output of the fibre, which is then imaged onto the sample plane when in use with an optical system. The collimator lens may be of a numerical aperture greater than or equal to the numerical aperture of the fibre to ensure no light is lost. The focal length of this collimating lens relative to the rest of the optical system controls the (de-)magnification of the fibre exit face onto the sample plane, thereby controlling the field of view.

In some embodiments, the coherent or partially coherent light source may have a bandwidth of between 1 to 10 nm. In some embodiments, the bandwidth may be more than 1, 2, 3, 4, 5, 6, 7, 8 or 9 nm. In some embodiments, the bandwidth may be less than 10, 9, 8, 7, 6, 5, 4, 3 or 2 nm.

The coherent or partially coherent light source can be configured to provide bright illumination to the sample. When coherent or partially coherent light is delivered in this way to the sample through a multimode fibre, mutual interference of the different modes can give rise to a speckle pattern that degrades the uniformity of the illumination, where the speckle contrast is reduced with reduced coherence (increased bandwidth) of the light source. Thus, additional means to reduce the speckle contrast are necessary to achieve uniform illumination, such as an increased length of fibre, mechanical agitation of the fibre, or perturbation of the input light into the fibre by rapid modulation of pointing or divergence by e.g. a deformable mirror.

In some embodiments, there is provided a critical illumination device where the optical fibre core can be circular. Alternatively, the optical fibre core may be non-circular such as a square or a rectangle, or an elliptical shape, a hexagon, octagon or any appropriate polygon. The non-circular optical fibre core can make more efficient use of the light by illuminating an area shaped to the camera readout, while also promoting a more homogeneous output for a given length of the fibre. In addition, non-circular optical fibre cores, such as square or rectangular optical fibre cores, can enhance scrambling as there are more angles that are possible for the light to utilise as it travels through the optical fibre.

In some embodiments, there is provided a critical illumination device wherein the length of the fibre can be at least 2 metres. Providing a fibre with a minimum of 2 metres can help maintain a uniform illumination. If the optic fibre becomes too short i.e. less than 1 metre, then the mode mixing may become inefficient. In some embodiments, it can be at least 5 metres. In some embodiments, the length of the fibre is at least 10 metres. In some embodiments, the length of the fibre may be between 2 to 500 metres. In some embodiments, the length of the fibre may be more than 2, 3, 4, 5, 10, 50, 100, 150, 200, 250, 300, 350, 400 or 450 metres. In some embodiments, the length of the fibre may be less than 500, 450, 400, 350, 300, 250, 200, 150, 100, 50, 10, 5, 4 or 3 metres. In some embodiments, the length of the fibre may be above 1 km long.

In some embodiments, the length of the optical fibre is at least 10 metres. Increasing the length of the fibre can be advantageous because it reduces speckle contrast. However, the longer the fibre, the greater the possibility of power losses. Therefore, it can be desirable to use only the length of fibre necessary to reduce speckle whilst providing sufficient power for illumination of the sample.

In some embodiments, a fibre length of over 10 metres with a modulated broadband laser can be provided, which results in the output light becoming more uniform and spatially incoherent with reduced speckle contrast.

In some embodiments, a 30 metres length of optical fibre can provide the optimal low speckle noise without excessive power loss.

In some embodiments, the partially or coherent light source according to any aspect of the present invention in combination with the optical fibre with a length of at least 10 metres enables critical illumination with high illumination uniformity on the object, as well as, minimising speckle contrast. As a result, this gives a high spatial resolution, high contrast microscope with reasonably uniform illumination capable for quantitative imaging of an object, such as a nanoparticle.

In some embodiments a critical illumination device, wherein the fibre core may have a diameter of between 15 microns to 400 microns. In some embodiments, the fibre core may have a diameter of more than 15, 30, 45, 60, 75, 90, 105, 120, 135, 150, 165, 180, 195, 210, 225, 240, 255, 270, 285, 300, 315, 330, 345, 360 or 385 microns. In some embodiments, the fibre core may have a diameter of less than 400, 385, 360, 345, 330, 315, 300, 285, 270, 255, 240, 225, 210, 200, 195, 190, 180, 165, 150, 135, 120, 105, 90, 75, 60, 45 or 40 microns.

The core and length of the optical fibre is an important consideration for providing uniform and spatially incoherent output light with reduced speckle contrast. In some embodiments, the optical fibre may include a 30 μm core size with a numerical aperture (NA) of 0.15. The higher fibre NA would give better speckle reduction, while using a shorter collimator e.g. f=6.5 mm would maintain a similar FoV and appropriate beam size.

In one example, the optical fibre may have a core size of 15 μm with a fibre NA of 0.25 in combination with a collimator lens (f) with a size of 3.3 mm. The parameters in this example are suitable for iSCAT microscope with a small field of view of the sample with a spatial filter provided in the back focal plane.

In some embodiments, the useful range of optic fibre parameters can span from approximately 50 μm core, 0.12 NA to 15 μm core, 0.25 NA. The higher NA fibres can provide better reduction in speckle contrast, but requiring smaller core sizes in order to maintain the desired field of view (FoV).

In some instances, increasing the fibre NA can be advantageous because the increased NA is better at reducing speckle contrast. In addition, the collimator focal length and fibre core size are decreased in order to maintain the target beam diameter and FoV. For example, the fibre core can range from 150 μm in diameter with 0.39 NA to 200 μm in diameter with 0.22 NA. In another example, the diameter of the fibre core can be up to 400 μm, NA 0.22 and a 9 mm collimator could be used with a larger (73 μm) FoV.

The skilled person would understand that the choice of fibre and collimator core numerical apertures and/or core diameter would also depend on the desired FOV and whether a spatial filter or mask is used. Typically, higher NAs are preferable for speckle reduction, but will require a corresponding reduction in core size and/or reduction in focal length of collimating lens in order to maintain relevant FoV and illumination NA.

Other possible combinations of fibre core sizes and NAs can be used, e.g. with larger illuminated areas corresponding to either lower sensitivity, or higher power requirements, which allows for larger core sizes and/or higher NAs to be used while still keeping the beam diameter below the mask diameter, if used.

In some embodiments, a critical illumination device further comprising a vibration module that is directly or indirectly connected to the optical fibre, such that the vibration module is configured to move the fibre.

The vibration module, such as a vibration motor or a voice coil, can be used to vibrate or shake the optical fibre in order to further reduce speckle. Alternatively or additionally, the length of the optic fibre can significantly increase up to 500 metres long to aid the reduction of speckle contrast.

In some embodiments, if additional/alternative speckle reduction approaches are required, physically moving/bending the optical fibre changes the speckle pattern at the output or tip of the fibre. Moving the fibre at a rate much faster than the integration time of the camera can reduce speckle contrast by averaging out different speckle patterns within an exposure time. These approaches may be used with a shorter fibre length to achieve the same speckle reduction as a longer fibre length without the increased risk of power losses.

In some embodiments, the speckle contrast can be reduced by rapidly changing the pointing or divergence of the input light into the fibre using the optical element such as a deformable mirror and/or a light deflecting element.

In some embodiments, a critical illumination device wherein the light source is a laser or an SLD. A super luminescent diode (SLD) can be used as a light source where the high powers achievable with a laser are not needed. The super luminescent diode may not require modulation.

In some embodiments, the laser can be modulated to induce a wavelength shift. This is particularly advantageous because it reduces the coherence in the light source. In some embodiments, a fibre of at least 10 metres may be provided with a low coherence light source, such as the modulated laser diode. The laser can be a modulated broadband laser. The modulated broadband laser may be used to reduce speckle contrast.

Imperfect temporal coherence i.e. a certain range of wavelengths being emitted leads to multiple fibre modes being used for efficient scrambling in the fibre. Modulation of diode lasers leads to their centre wavelength shifting by approximately 1 nm. Fast modulation (faster than the readout of the camera) can therefore increase the bandwidth used and as the speckle pattern at the end of the fibre will change with that modulation, it will average out over the read-out of the camera frame.

In some embodiments, a critical illumination device wherein the collimator lens is an achromatic collimator lens, an aspheric collimator lens or a reflective collimator lens for example, a curved mirror. The collimator lens (f) can be between 2 mm to 10 mm to give a suitable FoV and illumination NA. In some embodiments, the collimator lens (f) can be more than 3, 4, 5, 6, 7, 8, 9, 10 or 11 mm. In some embodiments, the collimator lens (f) can be less than 12, 11, 10, 9, 8, 7, 6, 5, 4 or 3 mm. In some embodiments, the aspheric collimator f=9.6 mm may be adjusted to image fibre end at infinity.

In some embodiments, the critical illumination device further comprising an objective lens.

In another aspect of the present invention, there is provided a reflection light microscope comprising:
a sample holder for holding a sample in a sample location;
a critical illumination device according to any one of the previous aspects of the invention, the illumination device is configured to provide uniform illumination of the sample;
a detector; and
an optical system being arranged to direct illuminating light onto the sample location and being arranged to collect output light in reflection, the output light comprising both light scattered from the sample location and illuminating light reflected from the sample location, and to direct the output light to the detector.

The use of a multimode optical fibre can significantly simplify the microscope instrument since few parts are required. This minimises parts cost and set up time. The illumination device including the coherent or partially coherent light source and the optic (multimode) fibre as disclosed herein, in conjunction with the optical system, can be configured to form an image of the tip of the fibre at the sample plane. This is important for enabling critical illumination with high uniformity illumination of the sample whilst reducing speckle contrast of the image.

The sample may be a liquid sample comprising objects to be imaged. The sample holder may take any form suitable for holding the sample. Typically, the sample holder holds the sample on a surface, which forms an interface between the sample holder and the sample. For example, the sample holder may be a coverslip and/or may be made from glass. The sample may be provided on the sample holder in a straightforward manner, for example using a micropipette. The sample location may be described as the surface on which the sample is disposed.

Optical fibre coupled with a light source, such as a laser module, can provide coherent or partially coherent light for bright illumination. As example only, a 1.5 W 525 nm laser can be provided with power of approximately 250 mW provided at the sample. Alternatively, a 3.5 W 465 nm laser may also be used as a light source.

In addition, the critical illumination device enables a large range of illumination angles for high spatial resolution than can be typically achievable in coherent imaging with little loss of contrast. The multimode optical fibre acting as a light source enables critical illumination with high illumination uniformity. By providing critical illumination together with the optical fibre, a high spatial resolution, high contrast microscope with excellent uniform illumination can be achieved for quantitative imaging of the sample. Without the multimode optical fibre acting as a highly uniform light source as disclosed herein, there would be non-uniform illumination due to the image of the light source.

The reflection light microscope can be an interferometric scattering or iSCAT microscope. In some embodiments, the reflection light microscope as described herein can be used for quantitative imaging of objects present in samples broadly in the 20 to 200 nm size range. In some embodiments, the reflection light microscope as described herein can be used for quantitative imaging of samples that are greater than 10, 20, 40, 60, 80, 100, 120, 140, 160 or 180 nm. In some embodiments, the reflection light microscope as described herein can be used for quantitative imaging of samples that are less than 200, 180, 160, 140, 120, 100, 80, 60, 40 or 20 nm.

The object present in the sample may be, but is not limited to, a viral vector such as adenovirus, AAV and/or lentivirus. The reflection microscope, which can be a single particle interferometric scattering microscope, can be used to analyse the genome content of the sample (i.e. empty/full) based on light scattering contrast. Such is critical for the quality assurance processes of new therapies based on such viral vectors, such as gene therapy.

Additionally or alternatively, the object in the sample can be, but is not limited to, a biomolecule such as a nucleic acid, a protein, a protein complex, a lipoprotein, a polypeptide, an antibody or antibody fragment thereof, an enzyme, a virus or a viral vector such as adenovirus, AAV and/or lentivirus, a particle, a nanoparticle, a compound, a molecule, an ion or a quantum dot. Alternatively the object can be a nanotube, nanowire, dendrimer, liposome, ethosome or aquasome, polymersome, niosome, or cubosome.

In some embodiments, the reflection light microscope may further comprise a spatial filter (or mask) positioned to filter the output light, the spatial filter being arranged to pass output light but with a reduction in intensity that is greater within a predetermined numerical aperture than at larger numerical apertures.

The spatial filter or mask can be positioned as close to the back of the objective lens as possible.

The spatial filter passes the output light but with a reduction in intensity that is greater within a predetermined numerical aperture than at larger numerical apertures.

As a result, the spatial filter selectively reduces the intensity of the illuminating light over scattered light, by taking advantage of the mismatch between the numerical aperture of reflected illuminating light and of light scattered from objects in a sample at the sample location. Thus, the spatial filter takes advantage of the different directionalities of these two sources of light. The reflected illuminating light will typically have a relatively small numerical aperture, whereas sub-diffraction-sized objects near a surface of the sample scatter light preferentially into high numerical apertures. Therefore, the reduction in intensity by the spatial filter at low numerical apertures predominantly affects the illuminating light and has minimal effect on the scattered light, thereby maximising the imaging contrast.

This effect may be maximised by arranging the spatial filter so that the predetermined numerical aperture is identical or similar to the numerical aperture of the illuminating light reflected from the sample location.

In some embodiments, the predetermined numerical aperture can be the numerical aperture of the illuminating light reflected from the sample location that is comprised in the output light.

In some embodiments, the spatial filter can be arranged to pass output light with a reduction in intensity within said predetermined numerical aperture to 10⁻¹ of the incident intensity or less.

In some embodiments, the spatial filter can be arranged to pass output light with a reduction in intensity within said predetermined numerical aperture to 10⁻² of the incident intensity or less.

In some embodiments, the optical system may comprise an objective lens.

In some embodiments, the optical system may comprise an aperture or a series of apertures. The series of apertures can be arranged within the optical system such that it optimises the stray light.

In some embodiments, the aspheric collimator f=9.6 mm may be adjusted to image fibre end at infinity. Aperture A1 is 1.3 mm diameter in etched steel for about 0.3 illumination NA at sample. Larger A1 had too much stray light with mask away from back focal plane.

In some embodiments, at least one aperture of the optical system has a diameter of between 1 to 5 mm. In some embodiments, at least one aperture has a diameter more than 1, 2, 3 or 4 mm. In some embodiments, at least one aperture has a diameter less than 5, 4, 3 or 2 mm. A series of apertures of the optical system, for example A₁, A₂, A₃, can be arranged to optimise any stray light. This is advantageous because it ensures that any light lost is minimal.

In some embodiments, the optical system may further comprise a beam splitter configured to separate the output light in reflection from the sample location from the illuminating light. In other words, the beam splitter can be configured to separate the signal to be detected from the sample location from the illuminating light.

In some embodiments, the reflection light microscope may further comprise a second detector.

The detector may be a camera such as a FLIR or Ximea or (high speed) Complementary metal-oxide semiconductor (CMOS) camera. The camera may provide magnification as near square FoV to match the circular optical fibre core. As an example only, the FoV of the camera can be 650×400 pixels at 350 frames per second (fps).

In some embodiments, the optical system may be configured to direct the first and second signals onto the first and second detectors, respectively.

In a further aspect of the present invention, there is provided a method of illuminating of an object, the method comprising
providing a critical illumination device comprising
   a coherent or partially coherent light source and
   an optical fibre having a core with a diameter of at least 15 microns with a numerical aperture of 0.1 to 0.5;
   at least one collimator lens positioned at the focal length from the tip of the optical fibre, wherein the collimator lens is configured to match the numerical aperture of the optical fibre to couple light out of optical fibre; and
   transmitting light from the light source through the fibre core in order to provide a uniform illumination of the object.

In a further aspect of the present invention, there is provided a method of illuminating of an object, the method comprising
providing a critical illumination device comprising
   a coherent or partially coherent light source and
   an optical fibre having a core with a diameter of at least 15 microns with a numerical aperture of 0.1 to 0.5;
   at least one collimator lens positioned at the focal length from the tip of the optical fibre, wherein the collimator lens is configured to match the numerical aperture of the optical fibre to couple light into and/or out of optical fibre; and
   transmitting light from the light source through the fibre core in order to provide a uniform illumination of the object.

In some embodiments, a method according to any one of the aspects of the present invention further comprising providing the coherent or partially coherent light source with a bandwidth of 1 to 10 nm. In some embodiments, wherein the bandwidth is more than 1, 2, 3, 4, 5, 6, 7, 8 or 9 nm. In some embodiments, wherein the bandwidth is less than 10, 9, 8, 7, 6, 5, 4, 3 or 2 nm.

The light source may be a laser. The method may further comprises the step of modulating the laser to induce a wavelength shift.

In some embodiments the method may further comprises the step of vibrating the optical fibre. The vibration module is directly or indirectly connected to the optical fibre so that, when in use, the vibration module causes the optical fibre to vibrate. The vibration module, such as a vibration motor, can be used to vibrate or shake the optical fibre in order to further reduce speckle.

In some embodiments, the method may further comprises the step of providing the optical fibre with a length of at least 10 metres. Increasing the length of the fibre can be advantageous because it reduces speckle contrast of the object being imaged. This in turn improves contrast resolution.

There are several techniques to reduce speckle contrast and improve contrast resolution of the object in the image. Speckle contrast reduction may include, but is not limited to one or more of the following: reducing coherence of the light source, using longer optical fibres of at least 10 metres in length; the use of square-core fibres for a given length i.e. at least 10 metres in length; rapid shaking/bending of fibre using one or more motors or a Fiberguide® De-Speckler system. This can be particularly important at low contrasts i.e. contrast from coverslip surface ˜1%, where speckle contrast in the illumination is large relative to surface roughness image.

In some embodiments, a method may further comprise the step of imaging the object using a detection module. The detection module can be a camera that can be used to provide an image of the object at the tip of the optical fibre. The detector may be a camera such as a CMOS camera e.g. FLIR or Ximea or (high speed). The camera may provide magnification as near square FoV to match the circular optical fibre core. The FoV of the camera can be 650×400 pixels at 350 fps.

The invention will now be further and more particularly described, by way of example only, and with reference to the accompanying drawings, in which:

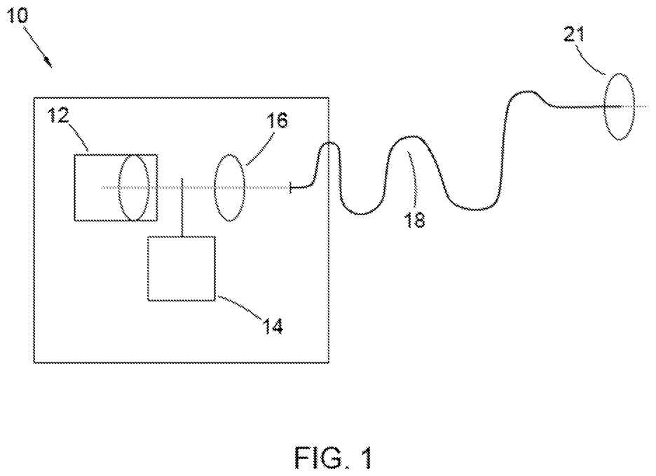

FIG. 1 is a schematic diagram of the fibre coupled laser module according to the present invention;

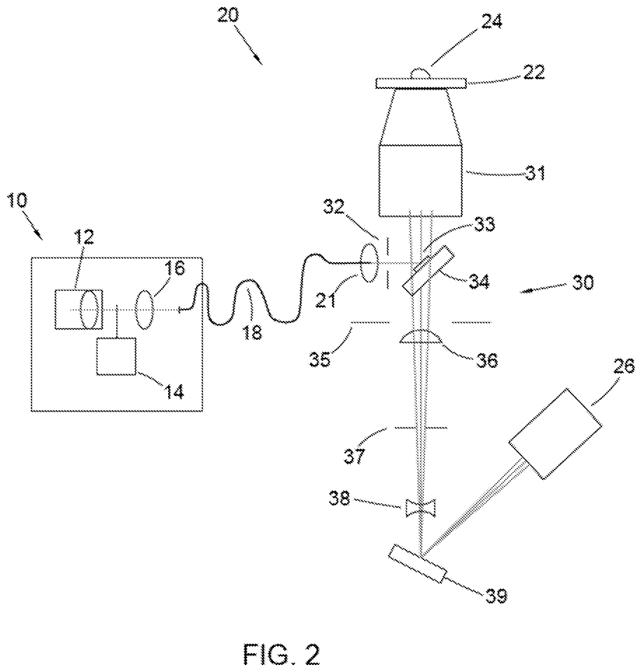

FIG. 2 is a schematic diagram of the fibre coupled laser module according to FIG. 1 used in conjunction with a reflection light microscope;

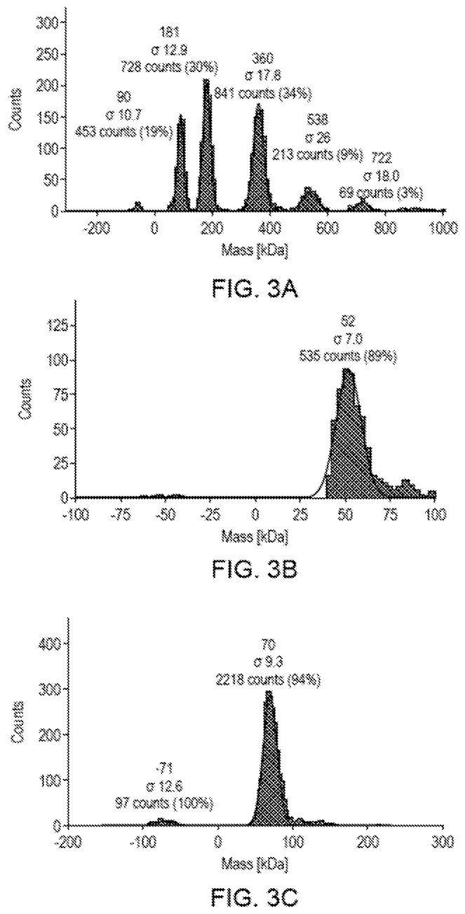

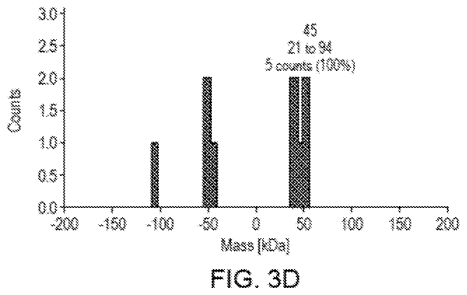

FIGS. 3A, 3B and 3C, 3D are experimental data of the detected objects by the apparatus and method of the present invention;

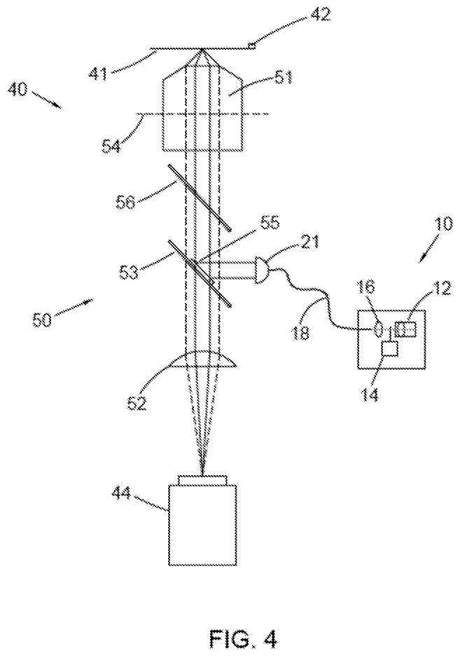

FIG. 4 is a schematic drawing of an iSCAT microscope;

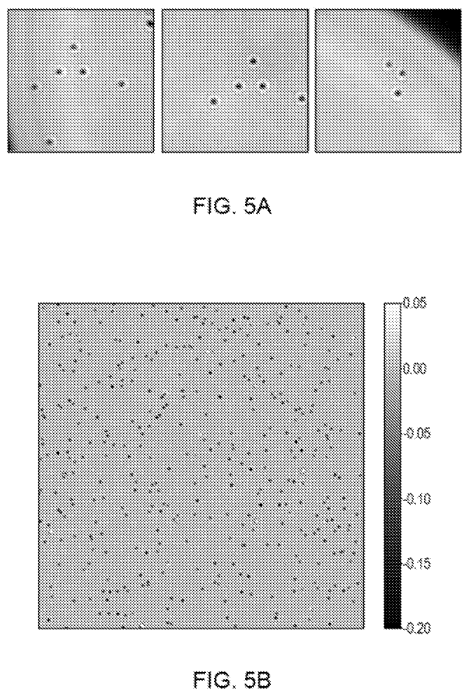

FIGS. 5A and 5B show images captured by the reflection light microscope;

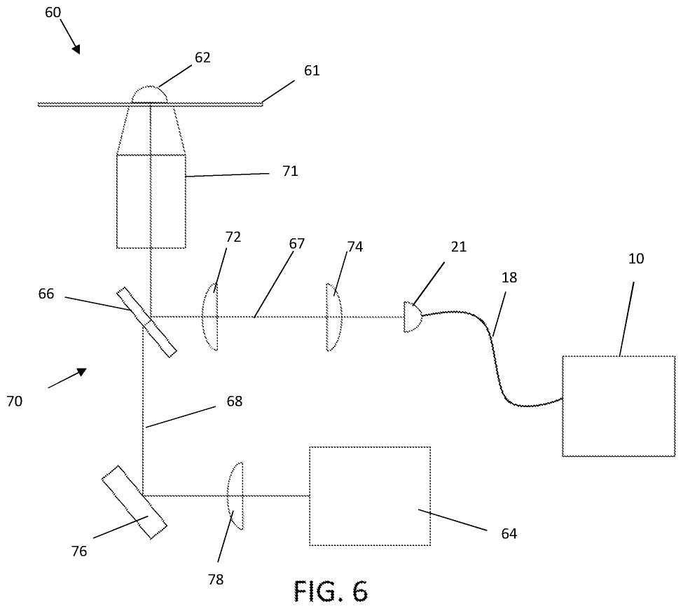

FIG. 6 is a schematic diagram of the illumination device coupled to a reflection light microscope; and

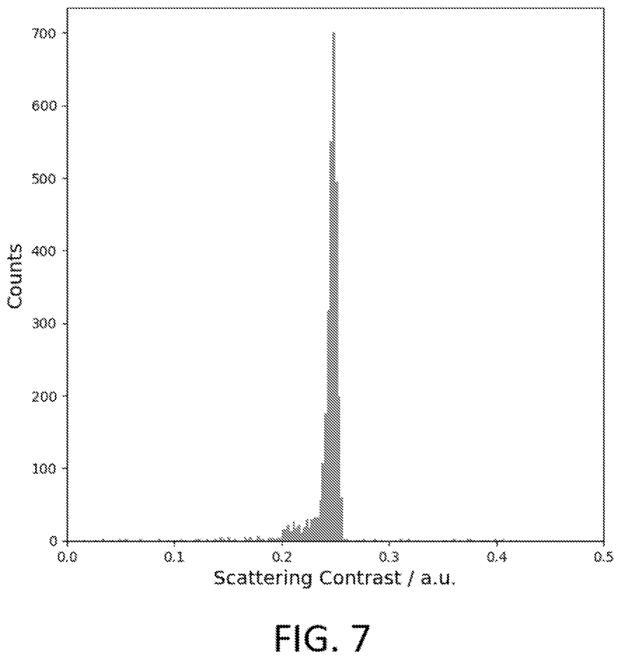

FIG. 7 shows a histogram of measured scattering contrast for the detection of adenovirus particles.

Referring to FIG. 1, there is provided a critical illumination device 10 comprising a light source 12, a modulator such as a shutter 14, a first collimator lens 16 and an optical fibre 18. The light source 12 provides light, which is focused onto the optical fibre 18 by the first collimator lens 16. The generated light may be coherent or partially coherent. The optical fibre 18 may be a multimode fibre. It is advantageous that the light source 12 be partially coherent as, when coupled with the optical fibre 18, it will utilise multiple fibre modes, which will efficiently scramble the light, which enables critical illumination with high illumination uniformity of the object.

The optical fibre 18 having a large number of modes can help reduce speckling of the image captured by the detector 26. Furthermore, increasing fibre length of the optical fibre 18 will further reduce speckling.

The first collimator lens 16 is configured to match with the numerical aperture of the optical fibre 18 to ensure that no light is lost and that all modes of the optical fibre 18 are efficiently used.

The light, coupled with the optical fibre 18, is then re-collimated at the second collimator lens 21, which can then be outputted to the reflection light microscope 20. The first and/or second collimator lens 16, 21 are positioned at the focal length from the tip of the optical fibre.

The shutter 14 is provided within the critical illumination device 10 to modulate the space between the optic fibre 18, first collimator lens 16 and the light source 12.

Referring to FIG. 2, there is provided a reflected light microscope 20. The reflected light microscope 20 comprises a sample holder 22 for holding one or more objects, such as a sample 24 at a sample location. The sample 24 may be a liquid sample comprising one or more particles to be imaged. The sample holder 22 may take any form suitable for holding the sample 24. Typically, the sample holder 22 holds the sample 24 on a surface, which forms an interface between the sample holder 22 and the sample 24. For example, the sample 24 may be provided on the sample holder 22 in a straightforward manner, for example, using a micropipette.

The reflected light microscope further comprises a critical illumination device 10 and a detector 26. The critical illumination device 10 is arranged to provide illuminating light to the sample 24.

The detector 26 receives output light in reflection from the sample location. The reflection light microscope 20 may be deployed in a wide-field mode, in which case the detector 26 may be an image sensor that captures an image of the sample 24. The detector may be a FLIR (Forward Looking Infrared), Ximea or (high speed) CMOS camera.

The reflection light microscope 20 further comprises an optical system 30 arranged between the sample holder 22, the critical illumination device 10 and the detector 26. The optical system 30 is arranged as follows to direct illuminating light onto the sample location for illuminating the sample 24, and to collect output light in reflection from the sample location and to direct the output light to the detector 26.

The optical system 30 includes an objective lens 31 which is a lens system disposed in front of the sample holder 22. The optical system 30 also includes a first aperture 32 configured to reduce the maximum diameter of the light such that the beam is not larger than the spatial filter 33 which is formed on the window 34. A second aperture 35 to reduce the maximum diameter of the light beam so that it is no larger than the first lens 36 and a third aperture 37 to reduce the maximum diameter of the light beam so that is no larger than the second lens 38. The optical system 30 further comprises a mirror 39 configured to reflect the output light so that it is incident on the detector 26. The output light incident on the detector 26 produces an image that is used to perform mass measurements and determine the mass of any objects in the sample.

The first lens 36 focuses the output light towards the third aperture 37 and the second lens 38. The second lens 38 focuses the output light towards the mirror 39 which then reflects the output light towards the detector 26. This is advantageous as it provides a greater magnification with a shorter beam path than if a single lens were used.

The objective lens 31 collects the output light, which comprises both (a) illuminating light reflected from the sample location and (b) light scattered from the sample 24 at the sample location. The reflected light is predominantly reflected from the interface between the sample holder 22 and the sample 24. Typically, this is a relatively weak reflection, for example a glass-water reflection. For example, the intensity of the reflected illuminating light may be of the order 0.5% of the intensity of the incident illuminating light. The scattered light is scattered by objects in the sample 24.

The scattered light from the objects at or close to the surface of the sample 24 constructively interfere with the reflected light and so are visible in the image captured by the detector 26.

As illustrated in FIG. 2, the reflected illuminating light and the scattered light have different directionalities. In particular, the reflected illuminating light has a numerical aperture resulting from the geometry of the beam of light output by the critical illumination device 10 and the optical system 30. The scattered light is scattered over a large range of angles and so fills a larger numerical aperture than the reflected illuminating light.

The output light from the objective lens 31 is incident on to the spatial filter 33, which is positioned to filter the output light passing to the detector 26. In the example shown in FIG. 2 in which the detector 26 is aligned with the optical path of the objective lens 31, the spatial filter 33 is therefore transmissive.

The spatial filter 33 is partially transmissive and therefore passes the output light, which includes the reflected illumination light, but with a reduction in intensity. The spatial filter 33 is also aligned with the optical axis and has a predetermined aperture so that it provides a reduction in intensity within a predetermined numerical aperture. Herein, numerical aperture is defined in its normal manner as being a dimensionless quantity characterising a range of angles with respect to the sample location from which the output light originates. Specifically, the numerical aperture (NA) may be defined by equation 1 as below:

$$NA = n \cdot sin ( θ ) \qquad ( equation 1 )$$

where θ is the half angle of collection and n is the refractive index of the material through which the output light passes (for example the material of the components of the optical system 30).

Referring to FIGS. 3A to 3D, there are provided experimental data of the detected objects using the apparatuses and method of the presently claimed invention. The graphs show the mass of the objects measured by the apparatus and method of the present invention as disclosed herein. For all measurements, the proteins were diluted to 5 nM final concentration in a droplet of 20 μl PBS in a silicon gasket on a cleaned coverslip and the contrast of single particles was recorded for 90 s.

In order to provide the desired uniform illumination it is important to have a collimator lens positioned at one focal length away from one end, i.e. the exit face, of the fibre to collect and collimate the output of the fibre, which is then imaged onto the sample plane when in use with an optical system. The collimator lens may be of a numerical aperture greater than or equal to the numerical aperture of the fibre to ensure no light is lost. The focal length of this collimating lens relative to the rest of the optical system controls the (de-)magnification of the fibre exit face onto the sample plane, thereby controlling the field of view. For example, in a setup such as shown in FIG. 2, the ratio of the focal lengths of the collimator and objective lens gives the magnification of the image of the end face of the fibre at the sample plane.

Referring to FIG. 3A, there is shown a plot of Mass in kDa versus counts for the results of Example 1 measuring a 90 kDa oligomerizing protein.

Referring to FIG. 3B there is shown a plot of Mass in kDa versus counts for the results of Example 1 measuring Protein A.

Referring to FIG. 3C there is shown a plot of Mass in kDa versus counts for the results of Example 1 measuring bovine serum albumin (BSA).

Referring to FIG. 3D there is shown there is shown a plot of Mass in kDa versus counts for the results of Example 1 measuring pure PBS buffer.

Referring FIG. 4, there is provided an iSCAT microscope 40. The microscope 40 comprises a sample holder 41 for holding a sample 42 at a sample location. The sample 42 may be a liquid sample comprising objects to be imaged, which are described in more detail below. The sample holder 41 may take any form suitable for holding the sample 42. Typically, the sample holder 41 holds the sample 42 on a surface, which forms an interface between the sample holder 41 and the sample 42. For example, the sample holder 41 may be a coverslip and/or may be made from glass. The sample 42 may be provided on the sample holder 41 in a straightforward manner, for example using a micropipette.

The microscope 40 further comprises a critical illumination device 10 and a detector 44. The critical illumination device 10 is arranged to provide illuminating light to the sample 42. The detector 44 receives output light in reflection from the sample location. Typically, the microscope 40 may operate in a wide-field mode, in which case the detector 44 may be an image sensor that captures an image of the sample 42. Examples of image sensors that may be employed as the detector 44 include a CMOS (complementary metal-oxide semiconductor) image sensor or a CCD (charge-coupled device).

The microscope 40 further comprises an optical system 50 arranged between the sample holder 41, the critical illumination device 10 and the detector 44. The optical system 50 is arranged to direct illuminating light onto the sample location for illuminating the sample 42, and to collect output light in reflection from the sample location and to direct the output light to the detector 44.

The optical system 50 includes an objective lens 51 which is a lens system disposed in front of the sample holder 41. The optical system 50 also includes a tube lens 52

The objective lens 51 collects the output light which comprises both (a) illuminating light reflected from the sample location (shown by continuous lines in FIG. 4), and (b) light scattered from the sample 3 at the sample location (shown by dotted lines in FIG. 4). The reflected light is predominantly reflected from the interface between the sample holder 41 and the sample 42. Typically, this is a relatively weak reflection, for example a glass-water reflection. For example, the intensity of the reflected illuminating light may be of the order of 0.5% of the intensity of the incident illuminating light. The scattered light is scattered by objects in the sample 43.

In a similar manner to conventional iSCAT, scattered light from objects at or close to the surface of the sample interfere with the reflected light and so are visible in the image captured by the detector 44. This effect differs from a microscope operating in transmission wherein the illuminating light that reaches the detector is transmitted through the depth of the sample leading to a much smaller imaging contrast.

As shown in FIG. 4, the reflected illuminating light and the scattered light have different directionalities. In particular, the reflected illuminating light has a numerical aperture resulting from the geometry of the beam of light output by the critical illumination device 10 and the optical system 50. The scattered light is scattered over a large range of angles and so fills larger numerical aperture than the reflected illuminating light. The tube lens 52 focuses the output light from the objective lens 51 onto the detector 44.

The optical system 10 also includes a window 53, a spatial filter 55 and a dichroic mirror 56 which directs the light towards the objective lens 51.

In addition to the components described above, the microscope 40 includes a spatial filter 55. In the example shown in FIG. 4, the spatial filter 55 is formed on the window 53 and is thereby positioned behind the back aperture of the objective lens 51, and so directly behind the back focal plane 54 of the objective lens 51. Thus, the spatial filter 55 may be implemented without entering the objective lens 51 as in phase contrast microscopy. Placing the spatial filter directly behind the entrance aperture of the objective lens 51 rather than in a conjugate plane (for example as described below) has the distinct advantage of strongly suppressing back reflections originating from the numerous lenses within high numerical aperture microscope objectives. This, in turn, reduces imaging noise, lowers non-interferometric background and reduces the experimental complexity, number of optics and optical path length leading to increased stability of the optical setup and thus image quality.

However, this location is not essential and a spatial filter having an equivalent function may be provided elsewhere as described below.

The spatial filter 55 is thereby positioned to filter the output light passing to the detector 44. In the example shown in FIG. 4 in which the detector 44 is aligned with the optical path of the objective lens 51, the spatial filter 55 is therefore transmissive.

The spatial filter 55 is partially transmissive and therefore passes the output light, which includes the reflected illumination light, but with a reduction in intensity. The spatial filter 55 is also aligned with the optical axis and has a predetermined aperture so that it provides a reduction in intensity within a predetermined numerical aperture. Herein, numerical aperture is defined in its normal manner as being a dimensionless quantity characterising a range of angles with respect to the sample location from which the output light originates. Specifically, the numerical aperture (NA) may be defined by equation 1.

FIGS. 5A and 5B show images of individual adenovirus particles captured by the apparatus using critical illumination. Adenovirus particles were diluted to 10⁻⁹/ml in PBS and a 20 μl droplet was placed in a silicon gasket on a cleaned coverslip. Viral particles were allowed to settle onto the glass surface for 2 minutes and an image covering the full illuminated area was taken. The data in FIG. 5A was taken on a microscope using critical illumination but with relatively low NA of illumination (i.e. angles), without the presence of a spatial filter. FIG. 5A shows particles close to the edges of the circular illuminated area.

As illustrated in FIG. 5A, the image has a relatively poor spatial resolution (seen in the distinct ringing out from each particle). It also illustrates the effects of wrongly positioning the output of the optical fibre along the optical axis. As a consequence of the wrongly positioned output of the optical fibre, the output from the fibre are not imaged onto the sample correctly. This causes aberrated PSFs at the edges of the illuminated area.

Referring to FIG. 5B, there is shown an image taken on a microscope using critical illumination with a multimode fibre at high illumination NA (>1), close to the full aperture of the objective lens), which is only possible when a spatial filter is not used. FIG. 5B shows particles close to the centre of the illuminated area, thus showing an even illumination of the full area. The high illumination NA results in improved spatial resolution i.e. the ‘ringing’ around each PSF are much less prominent away from the centre of the particle. As illustrated in FIG. 5B, the positioning of the output of the fibre was correct resulting in a round PSF across the field of view.

Referring to FIG. 6, there is shown an alternative microscope apparatus 60. The alternative microscope apparatus 60 as illustrated in FIG. 6 does not contain a spatial filter or mask. The microscope apparatus 60 comprises a sample holder 61 for holding a sample 62 at a sample location. The sample 62 may be a liquid sample comprising objects to be imaged. The sample holder 61 may take any suitable form for holding the sample 62. Typically, the sample holder 61 holds the sample 62 on a surface, which forms an interface between the sample holder 61 and the sample 62. For example, the sample holder 61 may be a coverslip and/or may be made from glass. The sample 62 may be provided on the sample holder 61 in a straightforward manner, for example using a micropipette.

The microscope apparatus 60 further comprises a critical illumination device 10 as disclosed herein, and a detector 64. The critical illumination device 10 is arranged to provide illuminating light to the sample 62. The detector 64 receives output light in reflection from the sample location. Typically, the microscope 60 may operate in a wide-field mode, in which case the detector 64 may be an image sensor that captures an image of the sample 62. Examples of image sensors that may be employed as the detector 64 include a CMOS (complementary metal-oxide semiconductor) image sensor or a CCD (charge-coupled device). The detector 64 may also be a camera.

The microscope 60 further comprises an optical system 70 arranged between the sample holder 61, the critical illumination device 10 and the detector 64. The optical system 70 is arranged to direct illuminating light onto the sample location for illuminating the sample 62, and to collect output light in reflection from the sample location. The output light is then directed to the detector 64.

The optical system 70 includes an objective lens 71 which is a lens system disposed in front of the sample holder 61. The objective lens 71 collects the output light, which comprises both (a) illuminating light reflected from the sample location provided around the sample holder 61, and (b) light scattered from the sample at the sample location provided around the sample holder 61. The reflected light is predominantly reflected from the interface between the sample holder 61 and the sample 62. Typically, this is a relatively weak reflection, for example a glass-water reflection. For example, the intensity of the reflected illuminating light may be of the order of 0.5% of the intensity of the incident illuminating light. The scattered light is scattered by objects in the sample 62.

In a similar manner to conventional iSCAT, scattered light from objects at or close to the surface of the sample interfere with the reflected light and so are visible in the image captured by the detector 64. This effect differs from a microscope operating in transmission wherein the illuminating light that reaches the detector is transmitted through the depth of the sample leading to a much smaller imaging contrast.

The light provided by the critical illumination device 10 is coupled with the optical fibre 18, which is then collimated at the collimator lens 21. This can then be outputted to the microscope 60. The collimator lens 21 can be positioned at the focal length from the tip of the optical fibre 18. The optical system further comprises a series of lenses 72, 74 to focus the illuminating light 67 from the critical illumination device 10.

The optical system also includes a beam splitter 66 that is arranged to split or separate the optical paths for the illuminating light 67 from the light source (not shown in FIG. 6) provided within the critical illumination device 10, and the output light 68 is directed to the detector 64. The beam splitter 66 may have a conventional construction that provides partial reflection and partial transmission of light incident thereon.

The optical system 70 further comprises a mirror 76 configured to reflect the output light 68 so that it is incident on the detector 64. A tube lens 78 is provided in order to focus the output light 68 from the objective lens 71 onto the detector 64. The output light 68 incident on the detector 64 produces an image that is used to perform mass measurements and determine the mass of any objects in the sample.

Referring to FIG. 7, there is provided a histogram (scattering contrast in arbitrary units vs count) showing the measured scattering contrast of adenovirus particles using the iSCAT microscope as illustrated in FIG. 6. The iSCAT microscope can be used to acquire images of adenovirus particles that have been immobilised on a clean coverslip surface. Adenoviral particles can be diluted to approximately 10⁻⁹ particles/ml in PBS, and 5 μl of this solution is then added to 10 μl of PBS in a silicone gasket well placed on a clean coverslip as described in Example 1. The droplet can be aspirated with a pipette to mix, and particles are allowed to settle on the surface for approximately 1 to 2 minutes.

Several images of 15 different fields of view on the same coverslip can then be acquired with the immobilised adenovirus particles positioned in focus, i.e. at the point at which the adenovirus show maximum contrast, and the scattering contrast of each particle is measured by an automated spot detection routine and 2D Gaussian fitting. The histogram as shown in FIG. 7 is generated from all measured particle contrasts in the 15 acquired images.

Various further aspects and embodiments of the present invention will be apparent to those skilled in the art in view of the present disclosure.

“and/or” where used herein is to be taken as specific disclosure of each of the two specified features or components with or without the other. For example “A and/or B” is to be taken as specific disclosure of each of (i) A, (ii) B and (iii) A and B, just as if each is set out individually herein.

Unless context dictates otherwise, the descriptions and definitions of the features set out above are not limited to any particular aspect or embodiment of the invention and apply equally to all aspects and embodiments which are described.

It will further be appreciated by those skilled in the art that although the invention has been described by way of example with reference to several embodiments, it is not limited to the disclosed embodiments and that alternative embodiments could be constructed without departing from the scope of the invention as defined in the appended claims. The invention has been used in the following non-limiting Examples:

### EXAMPLES

### Example 1

Borosilicate glass coverslips (No 1.5, 24×50 mm, VWR) were cleaned by sequential rinsing with MilliQ water, followed by ethanol and again MilliQ water. They were then dried under a stream of dry nitrogen. CultureWell silicone gaskets (Grace Bio-Labs) were cut and placed onto the freshly cleaned coverslip.

Various test samples were prepared from stock solutions. These include a 90 kDa oligomerising protein, Protein A, Bovine Serum Albumin (BSA) and pure phosphate buffered saline (PBS) buffer. For all measurements, the proteins were diluted to 5 nM final concentration in a droplet of 20 μl PBS in a silicon gasket on the cleaned coverslip. The contrast of single particles was recorded for 90 seconds.

Data acquisition and analysis was then carried out by an iSCAT microscope in the presence of a spatial filter and using the illumination device described herein, with non-specific binding of objects to the glass substrate being imaged and recorded. The images were acquired over 90 seconds.

Ratiometric image stacks were generated from the raw movie as previously described (such as in Cole et al., (ACS Photonics, 2017, 4(2), pp 211-216)). Objects landing on glass surface were identified in the ratiometric images by an automated spot detection routine based on 2D Gaussian fitting of the point spread function. The resulting ratiometric image reveals the binding of the object(s) to the cover glass surface.

Results are shown in FIG. 3 (A to D), providing plots of the signal contrast data acquired in the detection, and assigning mass to the peaks observed.

### Example 2

Apparatus as illustrated in FIG. 6 was used to acquire images of adenovirus particles immobilised on a clean coverslip surface. Adenoviral particles (stock solution) were diluted to 10⁻⁹ particles/ml in PBS and a 20 μl droplet was placed in a silicon gasket on a cleaned coverslip. Viral particles were allowed to settle onto the glass surface for approximately 2 minutes and an image covering the full illuminated area was taken.

The results are shown in FIG. 5. FIG. 5A shows particles close to the edges of the circular illuminated area, and FIG. 5B illustrates the centre of the illuminated area showing even illumination of the full area.

The data in FIG. 5A was taken on a microscope using critical illumination but with relatively low NA of illumination (i.e. angles), without the presence of a spatial filter. FIG. 5A shows particles close to the edges of the circular illuminated area. As illustrated in FIG. 5A, the image has a relatively poor spatial resolution (seen in the distinct ringing out from each particle). It also illustrates the effects of wrongly positioning the output of the optical fibre along the optical axis. As a consequence of the wrongly positioned output of the optical fibre, the output from the fibre are not imaged onto the sample correctly. This causes aberrated point spread functions (PSFs) at the edges of the illuminated area.

Referring to FIG. 5B, there is shown an image taken on a microscope using critical illumination with a multimode fibre at high illumination NA (>1), close to the full aperture of the objective lens), which is only possible when a spatial filter is not used. FIG. 5B shows particles close to the centre of the illuminated area, thus showing an even illumination of the full area. The high illumination NA results in improved spatial resolution i.e. the ‘ringing’ around each PSF are much less prominent away from the centre of the particle. As illustrated in FIG. 5B, the positioning of the output of the fibre was correct resulting in a round PSF across the field of view.

### Example 3

Apparatus as illustrated in FIG. 6 was used to acquire images of adenovirus particles immobilised on a clean coverslip surface. Adenoviral particles were diluted to approximately 10⁻⁹ particles/ml in PBS, and 5 μl of this solution added to 10 μl of PBS in a silicone gasket well placed on a clean coverslip as described in Example 1. The droplet was aspirated with a pipette to mix, and particles allowed to settle on the surface for 1-2 minutes.

Several images of 15 different fields of view on the same coverslip were acquired with the immobilised adenovirus particles positioned in focus (i.e. at the point at which they show maximum contrast), and the scattering contrast of each particles measured by an automated spot detection routine and 2D Gaussian fitting. The histogram FIG. 7 is generated from all measured particle contrasts in the 15 acquired images.

1. A critical illumination device for providing a uniform illumination of an object in a reflected light microscope, the critical illumination device comprising
a coherent or partially coherent light source;
an optical fibre coupled with the light source, wherein the fibre comprises a core with a diameter of at least 15 microns and a numerical aperture of 0.1 to 0.5; and
at least one collimator lens positioned at the focal length from the tip of the optical fibre, wherein the collimator lens is configured to match the numerical aperture of the optical fibre to couple light out of the optical fibre.

2. The critical illumination device according to claim 1, wherein the coherent or partially coherent light source has a bandwidth of 1 to 10 nm.

3. The critical illumination device according to claim 1, wherein the fibre core is non-circular.

4. The critical illumination device according to claim 1, wherein the length of the fibre is at least 2 metres.

5. The critical illumination device according to claim 1, wherein the fibre core has a diameter of between 15 microns to 400 microns.

6. The critical illumination device according to claim 1, further comprising a vibration module that is directly or indirectly connected to the optical fibre, such that the vibration module is configured to move the fibre.

7. The critical illumination device according to claim 1, further comprising an optical element.

8. The critical illumination device according to claim 1, wherein the light source is a laser or an SLD, wherein the laser is modulated to induce a wavelength shift.

9. (canceled)

10. The critical illumination device according to claim 1, wherein the collimator lens is an achromatic collimator lens or an aspheric collimator lens.

11. A reflection light microscope comprising:
a sample holder for holding a sample in a sample location;
a critical illumination device according to claim 1 configured to provide uniform illumination of the sample;
a detector; and
an optical system being arranged to direct illuminating light onto the sample location and being arranged to collect output light in reflection, the output light comprising both light scattered from the sample location and illuminating light reflected from the sample location, and to direct the output light to the detector.

12. The reflection light microscope according to claim 11, further comprising a spatial filter positioned to filter the output light, the spatial filter being arranged to pass output light but with a reduction in intensity that is greater within a predetermined numerical aperture than at larger numerical apertures; wherein the predetermined numerical aperture is the numerical aperture of the illuminating light reflected from the sample location that is comprised in the output light.

13. (canceled)

14. The reflection light microscope according to claim 12, wherein the spatial filter is arranged to pass output light with a reduction in intensity within said predetermined numerical aperture to 10⁻¹ of the incident intensity or less.

15. The reflection light microscope according to claim 11, wherein the optical system comprises an objective lens.

16. The reflection light microscope according to claim 11, wherein the optical system comprises a series of apertures.

17. The reflection light microscope according to claim 11, wherein at least one aperture having a diameter of between 1 to 5 mm.

18. The reflection light microscope according to claim 11, wherein the optical system further comprising a beam splitter configured to separate the output light in reflection from the sample location from the illuminating light.

19. A method of illuminating of an object, the method comprising
providing a critical illumination device comprising
a coherent or partially coherent light source and
an optical fibre having a core with a diameter of at least 15 microns with a numerical aperture of 0.1 to 0.5;
at least one collimator lens positioned at the focal length from the tip of the optical fibre, wherein the collimator lens is configured to match the numerical aperture of the optical fibre to couple light out of optical fibre; and
transmitting light from the light source through the fibre core in order to provide a uniform illumination of the object.

20. The method according to claim 19, further comprising the step of modulating the laser to induce a wavelength shift.

21. The method according to claim 19, further comprising the step of vibrating the optical fibre.

22. The method according to claim 19, further comprising the step of imaging the object using a detection module.
